(19) United States
(12) Patent Application Publication
(10) Pub. No.: US 2026/0019828 A1
(43) Pub. Date: Jan. 15, 2026

(54) BASE STATION APPARATUS, CONTROL APPARATUS, CONTROL METHOD, AND COMPUTER-READABLE STORAGE MEDIUM FOR CONTROLLING REFLECTION PATTERN OF REFLECTOR

(71) Applicant: KDDI Research, Inc., Fujimino-shi (JP)

(72) Inventors: Takuya OOTO, Fujimino-shi (JP); Takahiro HAYASHI, Fujimino-shi (JP); Hiromi MATSUNO, Fujimino-shi (JP); Tatsuya NAGAO, Fujimino-shi (JP)

(21) Appl. No.: 19/333,574

(22) Filed: Sep. 19, 2025

Related U.S. Application Data
(63) Continuation of application No. PCT/JP2024/003683, filed on Feb. 5, 2024.

(30) Foreign Application Priority Data
Mar. 20, 2023 (JP) 2023-044129

(51) Int. Cl. H04W 16/26

(52) U.S. Cl. CPC H04W 16/26

(57) ABSTRACT

A base station apparatus receives, from a control apparatus that controls a reflector that reflects radio waves transmitted from either the base station apparatus or a terminal apparatus, information indicating a time duration from when setting of a reflection pattern of the reflector is started to when the setting is complete, determines a specific reflection pattern to be set for the reflector and a first timing at which setting of the specific reflection pattern is to be complete, specifies a second timing that is either a certain timing earlier than the first timing by the time duration or a timing earlier than the certain timing, and transmits, to the control apparatus, an instruction signal instructing the control apparatus to set the specific reflection pattern, at the second timing.

### CROSS-REFERENCE TO RELATED APPLICATION(S)

This application is a continuation of International Patent Application No. PCT/JP2024/003683 filed on Feb. 5, 2024, which claims priority to and the benefit of Japanese Patent Application No. 2023-044129 filed on Mar. 20, 2023, the entire disclosures of which are incorporated herein by reference.

### BACKGROUND OF THE INVENTION

### Field of the Invention

The present invention relates to a technology for controlling the reflection pattern of a reflector.

### Description of the Related Art

In mobile communication, wireless communication services are provided to terminal apparatuses located at positions where radio waves transmitted by a base station apparatus can be received. Therefore, it is important to ensure that the radio waves transmitted by the base station apparatus appropriately reach the positions of the terminal apparatuses. Particularly in recent wireless communication environments, which tend to use high-frequency bands, radio quality is prone to degradation. Therefore, it is envisaged that the base station apparatus forms a beam to enhance radio quality through the gain of the beam. Additionally, the use of a reflector to reflect radio waves toward areas with low radio quality has been considered. Note that a reflector can change the direction of signal reflection by physically altering its orientation, but by using a metasurface reflector, radio waves can be reflected in various directions without changing the physical orientation. In Wu, Qingqing and Rui Zhang, “Intelligent reflecting surface enhanced wireless network: Joint active and passive beamforming design,” 2018 IEEE Global Communications Conference (GLOBECOM), 2018, a technology is described in which a base station apparatus transmits control information to a control apparatus of the reflector, thereby controlling the reflection pattern of radio waves on the reflector.

The base station apparatus enables highly efficient beam management by switching beams according to a specified detailed timing. Such beam management may also be required for the beam (reflection pattern) of the reflector. However, the reflector cannot switch between the beam patterns immediately upon receiving an instruction from the base station apparatus, which may hinder efficient operation.

### SUMMARY OF THE INVENTION

The present invention provides a technology for efficiently operating a reflector capable of changing its reflection pattern.

A base station apparatus according to one aspect of the present invention comprises: a reception unit configured to receive, from a control apparatus that controls a reflector that reflects radio waves transmitted from either the base station apparatus or a terminal apparatus, information indicating a time duration from when setting of a reflection pattern of the reflector is started to when the setting is complete; a determination unit configured to determine a specific reflection pattern to be set for the reflector and a first timing at which setting of the specific reflection pattern is to be complete; a specification unit configured to specify a second timing that is either a certain timing earlier than the first timing by the time duration or a timing earlier than the certain timing; and a transmission unit configured to transmit, to the control apparatus, an instruction signal instructing the control apparatus to set the specific reflection pattern, at the second timing.

A control apparatus according to one aspect of the present invention is a control apparatus for controlling a reflector that reflects radio waves transmitted from either a base station apparatus or a terminal apparatus, the control apparatus comprising: a notification unit configured to provide the base station apparatus with information indicating a time duration from when setting of a reflection pattern of the reflector is started to when the setting is complete; a reception unit configured to receive, from the base station apparatus, an instruction signal instructing to set a specific reflection pattern; and a setting unit configured to set the specific reflection pattern to the reflector.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram illustrating an example configuration of a system;

FIG. 2 is a diagram illustrating an example hardware configuration of an apparatus;

FIG. 3 is a diagram illustrating an example functional configuration of a base station apparatus;

FIG. 4 is a diagram illustrating an example functional configuration of a control apparatus; and

FIG. 5 is a diagram illustrating an example flow of processing executed in the system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Communication System

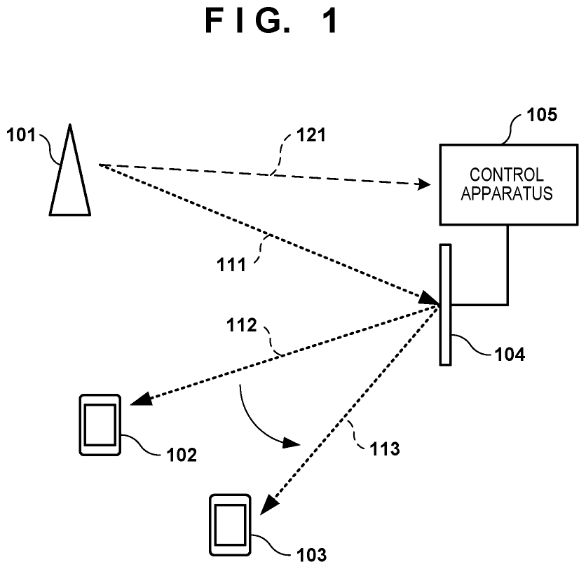

FIG. 1 shows an example configuration of a wireless communication system according to the present embodiment. The wireless communication system is, for example, a cellular communication system compliant with the 3rd Generation Partnership Project (3GPP (registered trademark)) cellular communication standards. However, the system is not limited to this, and the following discussion can be applied to a wireless communication system compliant with any wireless communication standard. The wireless communication system includes, for example, a base station apparatus 101, a terminal apparatus 102, and a terminal apparatus 103. Here, it is assumed that, due to the influence of obstructions such as buildings, the terminal apparatus 102 or the terminal apparatus 103 cannot receive radio waves transmitted from the base station apparatus 101 with sufficient power. In such cases, it is also assumed that the base station apparatus 101 cannot receive radio waves transmitted by the terminal apparatus 102 or the terminal apparatus 103 with sufficient power. In such situations, a reflector 104 may be used to enable communication between the base station apparatus 101 and the terminal apparatus 102 or the terminal apparatus 103. The reflector 104 reflects radio waves transmitted from the base station apparatus 101 with a predetermined reflection pattern. Additionally, the reflector 104 reflects radio waves transmitted from the terminal apparatus 102 with a predetermined reflection pattern. Here, each reflection pattern is determined by a reflection phase, which is set for the reflecting elements constituting the reflector, and corresponds, for example, to a combination of an incident pattern and an emission pattern. Note that an incident pattern is a pattern indicating the gain of the reflector for each incident direction. In other words, a radio wave incident from a predetermined incident direction is substantially not attenuated, whereas a radio wave incident from another incident direction is attenuated to nearly zero; such a pattern is the incident pattern. Similarly, an emission pattern is a pattern indicating the gain of the reflector for each emission direction. In other words, a radio wave is emitted with high power in a predetermined emission direction, whereas hardly any radio wave is emitted in another emission direction; such a pattern is the emission pattern. Due to this reflection pattern, in general, a radio wave incident from an incident direction with high gain is output in an emission direction with high gain.

Note that the configuration in FIG. 1 is merely an example. For example, there may be two or more reflectors relaying communication between the base station apparatus 101 and the terminal apparatus 102 or the terminal apparatus 103. Additionally, it is naturally envisaged that there may be three or more terminal apparatuses. Furthermore, some terminal apparatuses may communicate via the reflector, while others may communicate directly with the base station apparatus 101 without using the reflector. Moreover, the wireless communication system may include a large number of base station apparatuses. In such cases, other base station apparatuses may also perform communication using a reflector, similar to the base station apparatus 101.

The reflector 104 is configured to be capable of changing the reflection pattern of radio waves. For example, the reflector 104 can be configured to change the reflection direction of radio waves arriving from the base station apparatus 101 or from the terminal apparatus 102 or the terminal apparatus 103 by physically controlling the orientation of the reflector. The reflector 104 is, for example, an Intelligent Reflecting Surface (IRS). In one example, the IRS may be a liquid crystal reflector. In a liquid crystal reflector, by changing the permittivity of the liquid crystal layer disposed between the reflecting elements and the ground to manipulate the impedance and change the phase of the reflecting elements, it is possible to electrically control the reflection direction of the radio waves. Note that a liquid crystal reflector is merely an example of an IRS, and other types of reflectors may be used. For example, a reflector capable of changing the phase of reflecting elements using diodes or Micro Electro Mechanical Systems (MEMS) may be used. The reflector 104 is connected to a control apparatus 105. The control apparatus 105 performs control to change the reflection pattern of the reflector 104. The control apparatus 105, for example, outputs a control signal to the reflector 104 to adjust the reflection pattern of the IRS. Note that the control apparatus 105 may be an apparatus built into the reflector 104. Alternatively, the control apparatus 105 may be an apparatus provided externally to the reflector 104. Additionally, although FIG. 1 illustrates an example in which the control apparatus 105 is connected to one reflector 104, the control apparatus 105 may be connected to a plurality of reflectors. When the control apparatus 105 is connected to a plurality of reflectors, the control apparatus 105 may be configured to be capable of independently controlling the reflection pattern of each of the plurality of reflectors.

Here, it is assumed that the reflector 104 uses a reflection pattern in which a radio wave output from the base station apparatus 101 and arriving from a direction 111 is reflected in a direction 112. In this case, the terminal apparatus 102 can receive radio waves transmitted from the base station apparatus 101 and reflected by the reflector 104 with sufficient power. On the other hand, by changing the reflection pattern of the reflector 104 so as to reflect radio waves from the base station apparatus 101 toward a direction 113, the terminal apparatus 103 can also receive radio waves transmitted from the base station apparatus 101 and reflected by the reflector 104 with sufficient power. The reflection pattern of the reflector 104 may be changed, for example, based on an instruction from the base station apparatus 101 (or a network node). In one example, it is assumed that the control apparatus 105 has the functionality of a terminal apparatus compliant with the 5th generation (5G) cellular communication standard of 3GPP (registered trademark) and can receive a signal 121 from the base station apparatus 101. Here, the signal 121 from the base station apparatus 101 is a control signal for controlling the reflector 104. The control apparatus 105 sets the reflection pattern of radio waves for the reflector 104 connected thereto, based on the signal 121 from the base station apparatus 101.

It is necessary that the reflection pattern of the reflector 104 has been switched to another pattern at the appropriate timing. In other words, for example, at the timing when the terminal apparatus 103 performs communication, it is necessary that the reflection pattern of the reflector 104 has been set so as to reflect the radio waves from the base station apparatus 101 toward the direction 113. On the other hand, due to constraints on the response speed of the reflector 104, a certain amount of time is required to complete the change of the reflection pattern, and the instruction to change the reflection pattern needs to be transmitted from the base station apparatus 101 to the control apparatus 105 the certain amount of time earlier than the timing of the reflection pattern change. However, since the certain amount of time may vary for each reflector, the base station apparatus 101 cannot predetermine the timing at which the instruction to change the reflection pattern is to be transmitted.

In the present embodiment, in view of such circumstances, the control apparatus 105 provides the base station apparatus 101 with a time duration T0, which is a certain period of time required until the change of the reflection pattern of the reflector 104 is complete. Then, the base station apparatus 101 performs change instruction transmission control so that the transmission of the instruction to change the reflection pattern to the control apparatus 105 is complete at a second timing T1-T0, which is earlier than a first timing T1 for changing the reflection pattern of the reflector 104 by the provided time duration T0. For example, the base station apparatus 101 may transmit the instruction to change the reflection pattern at a third timing T1-T0-Δt, using a predetermined time offset Δt (>0). This predetermined time offset Δt may be set, for example, to a time corresponding to at least one of, or the sum of, the signal propagation time from the base station apparatus 101 to the control apparatus 105, the time for demodulation and decoding of the signal at the control apparatus 105, and the time required for control, including, for example, control performed to input an instruction from the control apparatus 105 to the reflector 104. Note that the control apparatus 105 may provide the base station apparatus 101 with the time duration corresponding to T0+Δt. Additionally, the control apparatus 105 may provide the base station apparatus 101 with information regarding the certain time duration by the number of slots corresponding to the time duration. For example, if the time duration of a time slot is t milliseconds, information regarding the time duration T0 milliseconds may be indicated as ceil (T0/τ). Here, ceil (x) is the ceiling function, indicating the smallest integer greater than the argument x. In other words, information regarding the time duration T0 may be provided to the base station apparatus 101 in any format.

This ensures that the control apparatus 105 can reliably complete the reception of the change instruction at the second timing T1-T0. Then, the control apparatus 105 controls the reflector 104 to change the reflection pattern over the certain time duration T0. As a result, it is possible to ensure that the change of the reflection pattern of the reflector 104 is complete at the first timing T1. In other words, by recognizing this certain time duration T0, the base station apparatus 101 can reliably set the reflection pattern of the reflector 104 at the intended timing. Note that this control may be performed dynamically or semi-statically. In other words, the base station apparatus 101 may perform control to frequently change the reflection pattern of the reflector 104, or control the reflector 104 such that the use of a specific reflection pattern starts at a specific timing and that reflection pattern is fixed for a long term. Note that, when dynamically setting the reflection pattern, the base station apparatus 101 may transmit an instruction signal to the control apparatus 105 to sequentially change a plurality of reflection patterns. In this case, the instruction signal may include a plurality of reflection patterns and information indicating the timing at which each reflection pattern is to be set. Then, the base station apparatus 101 may identify the second timing T1-T0 based on the first timing T1 at which the setting of the first reflection pattern is to be complete and the certain time duration T0 required for changing the reflection pattern, and transmit that information at the second timing or earlier. Note that the timings corresponding to the plurality of reflection patterns included in that information may be a timing T3 at which the setting of each reflection pattern is to be complete or a timing T3-T0 at which the setting of each reflection pattern is to start.

Note that, when providing the base station apparatus 101 with information regarding the above time duration T0, the control apparatus 105 may also provide the identification information of the reflector 104. As a result, the base station apparatus 101 can transmit an instruction signal, specifying the individual reflector 104. Note that, if it is known that the control apparatus 105 corresponds to only one reflector 104, the identification information may be the identification information of the control apparatus 105. In this case, when the control apparatus 105 has the functionality of a terminal apparatus capable of communicating with the base station apparatus 101, the identification information of the control apparatus 105 may be the identification information of that terminal apparatus. In other words, when the control apparatus 105 connects to the base station apparatus 101, the identification information of the reflector 104 may be implicitly provided to the base station apparatus 101. By providing the base station apparatus 101 with the identification information of the reflector 104 in this way, the base station apparatus 101 can transmit an instruction signal dedicated to the individual reflector 104 at a timing suitable for that reflector 104.

The control apparatus 105 can provide the base station apparatus 101 with the information of the time duration T0 in various formats. For example, the control apparatus 105 may provide the base station apparatus 101 with the information of the above time duration T0 as part of UE Capability, which is its capability information. Additionally, the control apparatus 105 may, for example, include that information in a message of the random access procedure when establishing a connection with the base station apparatus 101, and transmit the message. As an example, the random access preamble sequence or the time and frequency resources used for transmission may be associated with the time duration T0 in advance, and the control apparatus 105 may generate a random access preamble using the sequence corresponding to the time duration T0 to be transmitted, and transmit that random access preamble in the time and frequency resources corresponding to that time duration T0. Additionally, the control apparatus 105 may transmit that information to the base station apparatus 101 in Message 3 of the random access procedure. Additionally, the control apparatus 105 may use uplink control information (UCI) after connection establishment, and provide the base station apparatus 101 with that information. Furthermore, if a protocol layer dedicated to the reflector is defined, the information of the time duration T0 may be provided to the base station apparatus 101 through a message in the protocol layer.

### Apparatus Configuration

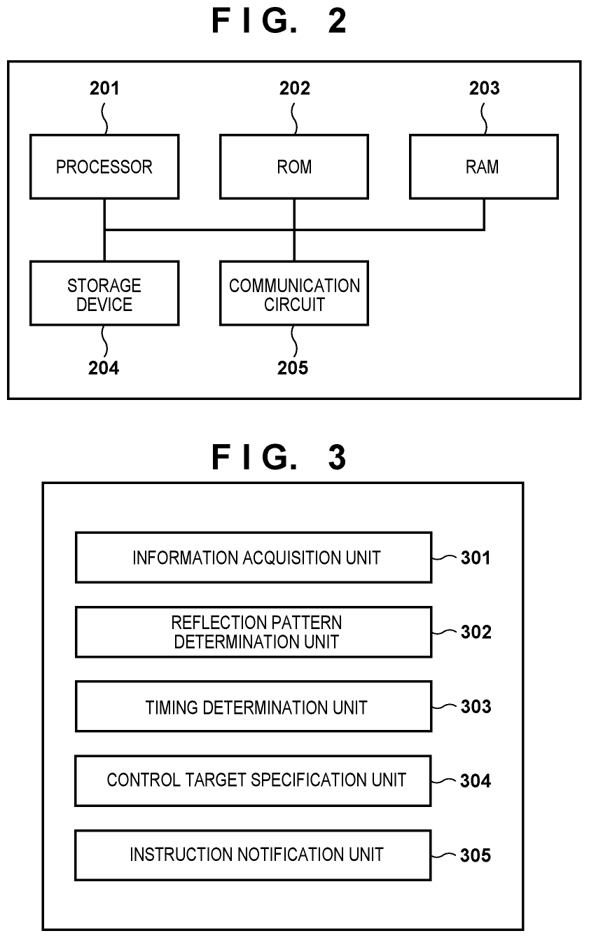

Next, an example configuration of the base station apparatus 101 and the control apparatus 105 described above will be described. Note that, in the following description, the base station apparatus 101 is referred to as the base station apparatus, and the control apparatus 105 is referred to as the control apparatus, without using reference numerals. FIG. 2 is a diagram illustrating an example hardware configuration of the base station apparatus and the control apparatus. In one example, the base station apparatus and the control apparatus each include a processor 201, a ROM 202, a RAM 203, a storage device 204, and a communication circuit 205. The processor 201 is a computer including one or more processing circuits, such as a general-purpose CPU (Central Processing Unit) or an ASIC (Application-Specific Integrated Circuit), and performs processing regarding the entire apparatus or the above-described processing by reading and executing programs stored in the ROM 202 or the storage device 204. The ROM 202 is a read-only memory that stores programs and various parameters related to the processing executed by the base station apparatus or the control apparatus. The RAM 203 is a random access memory that functions as a workspace when the processor 201 executes programs, and that stores temporary information. The storage device 204 is constituted, for example, by a removable external storage device or the like. The communication circuit 205 includes, for example, circuits for wired or wireless communication performed by the base station apparatus or the control apparatus. For example, the base station apparatus may include circuits for wireless communication compliant with LTE or 5G for communication with the terminal apparatus 102 or the terminal apparatus 103. Note that the base station apparatus may communicate with the control apparatus using, for example, the communication circuit 205 for LTE or 5G. However, this is merely an example, and the base station apparatus may be configured to communicate with the control apparatus using a communication circuit 205 for wired or wireless communication prepared separately from the communication circuit 205 for LTE or 5G. The control apparatus includes a communication circuit 205 for wireless or wired communication to communicate with the base station apparatus. Additionally, the control apparatus may further include a communication circuit 205 for communication with the reflector (e.g., wired communication). Although one communication circuit 205 is illustrated in FIG. 2, the base station apparatus and the control apparatus may each include a plurality of communication circuits. Note that a plurality of communication functions may be implemented by a single communication circuit 205.

FIG. 3 is a diagram illustrating an example functional configuration of the base station apparatus. The base station apparatus includes, as its functions, for example, an information acquisition unit 301, a reflection pattern determination unit 302, a timing determination unit 303, a control target specification unit 304, and an instruction notification unit 305. Note that these functional units may be realized, for example, by the processor 201 executing programs stored in the ROM 202 or the storage device 204 and, as necessary, controlling the communication circuit 205. However, the present invention is not limited to such a configuration, and dedicated hardware for realizing each function may be provided, for example.

The information acquisition unit 301 acquires information regarding the time (response time) required to change the reflection pattern of the reflector from the control apparatus that controls the reflector. In other words, the information acquisition unit 301 acquires, from the control apparatus, information regarding the time duration T0, which is a certain period of time from when the control apparatus instructs the change of the reflection pattern to when the change of the reflection pattern is complete. Note that this time duration may include processing times Δt such as the time required for communication between the base station apparatus and the control apparatus and the time from when the control apparatus receives an instruction from the base station apparatus to when the control apparatus controls the reflector. In other words, the information acquisition unit 301 may acquire, from the control apparatus, the time T0+Δt from when the base station apparatus transmits an instruction signal to when the change of the reflection pattern is actually complete, as the information regarding the time duration described above. Note that the information regarding the time duration may be expressed in units of “seconds” or in other units such as the number of time slots. Additionally, the information acquisition unit 301 may acquire identification information of the reflector controlled by the control apparatus. Note that, if the reflector can be identified by specifying the control apparatus, the identification information of the reflector may be the identification information of the control apparatus. Additionally, for example, when there is only one reflector in the area of the base station apparatus or when there is no need to distinguish between reflectors, the information specifying the identification information of the reflector(s) may be omitted. The information acquisition unit 301 may, for example, request the provision of UE Capability from the control apparatus, and may acquire the above-described information from the UE Capability. Additionally, the information acquisition unit 301 may acquire the above-described information from Message 1 (random access preamble) or Message 3 of the random access procedure, or UCI, transmitted when the control apparatus connects to the base station apparatus. Additionally, if a protocol layer for controlling the reflector is defined, the information acquisition unit 301 may acquire the above-described information through a message in the protocol layer.

The reflection pattern determination unit 302 determines the reflection pattern to be set for the reflector. For example, the reflection pattern determination unit 302 specify reflection patterns corresponding to the positions of terminal apparatuses in advance, and when the communication partner terminal apparatus is determined, the reflection pattern determination unit 302 determines to use the reflection pattern corresponding to the terminal apparatus. In this case, the reflection pattern determination unit 302 may determine that the reflection pattern is to be dynamically changed each time the communication partner terminal apparatus switches to another apparatus. Additionally, for example, to accommodate a large number of terminal apparatuses at an event venue or the like, the reflection pattern determination unit 302 may determine a reflection pattern to temporarily direct a beam toward the venue. In this case, the reflection pattern determination unit 302 may determine that the same reflection pattern is to be used semi-statically over a certain period of time.

The timing determination unit 303 determines the timing at which the reflection pattern determined by the reflection pattern determination unit 302 is to be set for the reflector and the transmission timing of the instruction signal for that setting. Here, the timing determination unit 303 determines the transmission timing of the instruction signal, for example, based on the information regarding the time duration acquired by the information acquisition unit 301, so that the setting of the reflection pattern is complete at a predetermined timing. For example, using the timing T1 at which the setting of the reflection pattern is to be complete and the provided time duration T0, the transmission timing of the instruction signal is determined to be T1-T0 or earlier. Note that, when determining reflection patterns in parallel for a plurality of reflectors reflecting the radio waves of the base station apparatus, the timing determination unit 303 may determine the timing for changing the reflection pattern and the transmission timing of the instruction signal for that change individually for each of the plurality of reflectors. Note that a common reflection pattern change timing or instruction signal transmission timing may be determined for a plurality of reflectors. Additionally, when a plurality of reflection patterns are to be sequentially switched for use in one reflector, the timing determination unit 303 may determine the change timing of the reflection pattern for each of the plurality of reflection patterns. At this time, when providing the change instructions for a plurality of reflection patterns at once, the timing determination unit 303 may determine the transmission timing of the instruction signals based on the earliest timing among the change timings for the plurality of reflection patterns and the time duration acquired from the control apparatus. Note that, when a change instruction is provided separately for each of the plurality of reflection patterns, the transmission timing of the instruction signal may be determined based on the change timing corresponding to the reflection pattern and the time duration information acquired from the control apparatus.

The control target specification unit 304 specifies which reflector's reflection pattern to control when, for example, a plurality of reflectors to be controlled are present. The control target specification unit 304 may be omitted if it is known in advance that only one reflector is to be controlled. Additionally, when the order of changing the reflection patterns for a plurality of reflectors is determined in advance and the instruction signal triggers the change of the reflection patterns for the plurality of reflectors simultaneously, it may be unnecessary to distinguish between the plurality of reflectors. In such cases, the control target specification unit 304 may be omitted.

The instruction notification unit 305 provides, to the control apparatus corresponding to the reflector to be controlled, an instruction signal including information indicating the reflection pattern determined by the reflection pattern determination unit 302 and information indicating the timing at which that reflection pattern is to be set. The instruction notification unit 305 provides the control apparatus with the information indicating the reflection pattern through broadcast transmission or individual signaling. Note that the instruction notification unit 305 transmits the instruction signal to the control apparatus at the timing determined by the timing determination unit 303 or at a timing earlier than that timing.

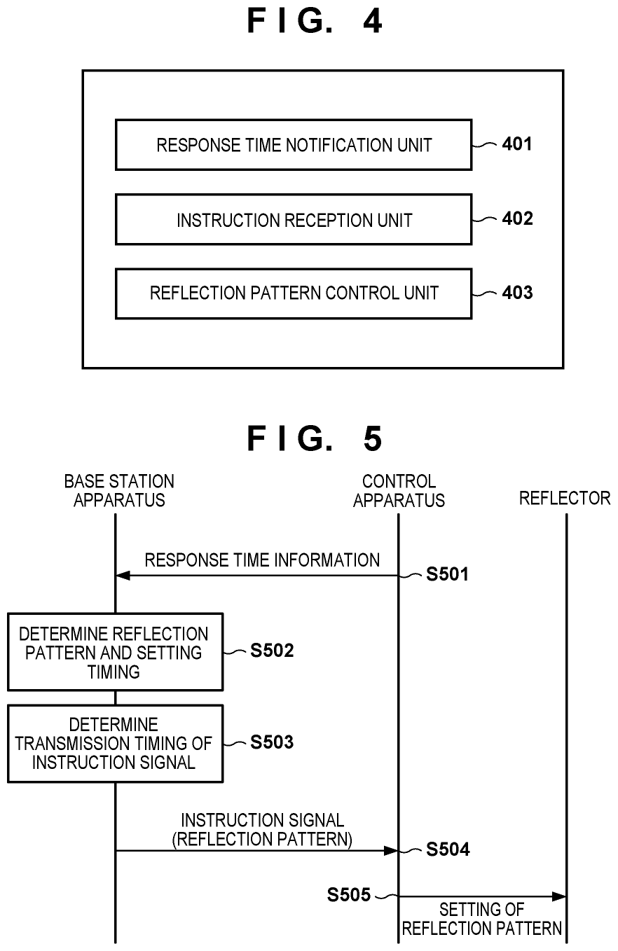

FIG. 4 is a diagram illustrating an example functional configuration of the control apparatus. The control apparatus includes, as its functions, for example, a response time notification unit 401, an instruction reception unit 402, and a reflection pattern control unit 403. Note that these functional units may be realized, for example, by the processor 201 executing programs stored in the ROM 202 or the storage device 204 and, as necessary, controlling the communication circuit 205. However, the present invention is not limited to such a configuration, and dedicated hardware for realizing each function may be provided, for example.

The response time notification unit 401 specifies the time duration (response time) required to change the reflection pattern for the reflector controlled by the control apparatus. Note that this time duration may include the time for communication with the base station apparatus or the time from when the instruction signal is received to when control information for the reflector is input. Then, the response time notification unit 401 provides information regarding the specified time duration to the base station apparatus. The instruction reception unit 402 receives, from the base station apparatus, an instruction signal instructing the change of the reflection pattern of the reflector. This instruction signal includes, for example, information specifying the reflection pattern to be set for the reflector and information specifying the timing at which that reflection pattern is to be set. The reflection pattern control unit 403 sets the reflection pattern of the reflector connected to the control apparatus based on the pattern information included in the received instruction signal. Note that the reflection pattern control unit 403 may start controlling the reflector, considering the time duration specified by the response time notification unit 401, so that the setting of the reflection pattern is complete at the timing specified in the instruction signal. Note that the instruction reception unit 402 may receive identification information for specifying the reflector along with the information specifying the reflection pattern. Then, when the instruction reception unit 402 receives an instruction signal including identification information corresponding to the reflector connected to the control apparatus, the instruction reception unit 402 acquires the reflection pattern information included in that instruction signal. Then, the reflection pattern control unit 403 sets the reflection pattern of the reflector based on that reflection pattern information.

### Processing Flow

Next, an example of the flow of processing executed in the wireless communication system will be described with reference to FIG. 5. Note that, since the details of the processing have been described above, the overview of the processing flow is presented here, and the details are not repeated.

First, in this processing, the control apparatus provides the base station apparatus with information regarding the response time required from the start of setting the reflection pattern of the reflector to its completion (S501). For example, the control apparatus may operate as a 5G terminal apparatus and provide the response time information during the random access procedure for establishing a connection with the base station apparatus. Additionally, the control apparatus may, for example, include the response time information in the UE Capability and transmit the UE Capability including the information after establishing a connection with the base station apparatus. Note that the UE Capability may be transmitted in response to a request from the base station apparatus. Additionally, the control apparatus may, for example, provide the base station apparatus with the response time information, using UCI. Note that the control apparatus may include the response time information in the UCI used to transmit ACK for hybrid automatic repeat request (HARQ), channel state information, scheduling requests, or the like, and transmit the UCI including the information. The base station apparatus receives the response time information.

It is assumed that the base station apparatus thereafter determines that the reflection pattern of the reflector connected to the control apparatus is to be changed. At this time, the base station apparatus also determines the timing at which the change of the reflection pattern is to be complete (S502). In one example, the base station apparatus may determine the reflection pattern and the setting completion timing so that communication is possible, based on the position of the terminal apparatus and the communication schedule with that terminal apparatus. Then, the base station apparatus specifies the timing that is earlier than the setting completion timing by the time duration of the response time acquired in S501, as the timing at which the transmission of the instruction signal instructing the change of the reflection pattern is to be complete (S503). Then, the base station apparatus provides the control apparatus with the instruction signal including the reflection pattern to be set, at that timing or at a timing earlier than that timing (S504). Note that the base station apparatus may further include, in the instruction signal, information regarding the timing at which the setting of the reflection pattern specified by the instruction signal is to be complete, and transmit the instruction signal including the information. Additionally, when a plurality of reflectors are used for the communication of the base station apparatus, the base station apparatus includes information indicating which reflector the instruction pertains to in the instruction signal, and transmit the instruction signal including the information. Note that the information indicating which reflector the instruction pertains to may be, for example, the identification information of the reflector. Note that, when only one reflector is connected to the control apparatus, the identification information of the control apparatus may be used as the identification information of the reflector. Note that the instruction signal may be transmitted as user data for the terminal apparatus. In this case, by specifying the control apparatus as the destination of the user data, the instruction signal in the user data may be identified as in instruction pertaining to the reflector connected to that control apparatus.

Upon receiving the instruction signal, the control apparatus sets the reflector to reflect radio waves with the specified reflection pattern (S505). Note that the control apparatus may set the reflection pattern of the reflector immediately after receiving the instruction signal. As a result, it is possible to ensure that the reflector can reliably reflect radio waves with that reflection pattern at the timing at which the setting of the reflection pattern is to be complete. Additionally, if the instruction signal includes information specifying the timing at which the setting of the reflection pattern is to be complete, the control apparatus may wait until the timing that is the aforementioned waiting time earlier than that timing and then start setting the reflector. As a result, it is possible to prevent the setting from being performed at an unnecessarily early timing.

As described above, in the present embodiment, information regarding the response time required for setting the reflection pattern of the reflector is provided to the base station apparatus. As a result, the base station apparatus can specify the timing at which the instruction signal is to be transmitted, based on the timing at which the setting of the reflection pattern is to be complete. By transmitting the instruction signal at such timing, the reflector can reflect radio waves with the specified reflection pattern at the appropriate timing. Therefore, it is possible to contribute to Goal 9 of the Sustainable Development Goals (SDGs) led by the United Nations: “Build resilient infrastructure, promote sustainable industrialization, and foster innovation”.

The invention is not limited to the foregoing embodiments, and various variations/changes are possible within the spirit of the invention.

What is claimed is:

1. A base station apparatus comprising:
a reception unit configured to receive, from a control apparatus that controls a reflector that reflects radio waves transmitted from either the base station apparatus or a terminal apparatus, information indicating a time duration from when setting of a reflection pattern of the reflector is started to when the setting is complete;
a determination unit configured to determine a specific reflection pattern to be set for the reflector and a first timing at which setting of the specific reflection pattern is to be complete;
a specification unit configured to specify a second timing that is either a certain timing earlier than the first timing by the time duration or a timing earlier than the certain timing; and
a transmission unit configured to transmit, to the control apparatus, an instruction signal instructing the control apparatus to set the specific reflection pattern, at the second timing.

2. The base station apparatus according to claim 1,
wherein the transmission unit further includes information indicating the first timing in the instruction signal and transmits the instruction signal.

3. The base station apparatus according to claim 1,
wherein the reception unit receives UE Capability of the control apparatus, including information indicating the time duration.

4. The base station apparatus according to claim 1,
wherein the reception unit receives Message 1 or Message 3 of a random access procedure, uplink control information (UCI), or a message in a protocol layer for controlling the reflector, each of which includes information indicating the time duration.

5. The base station apparatus according to claim 1,
wherein the reception unit receives information regarding the number of time slots corresponding to the time duration as information indicating the time duration.

6. A control apparatus for controlling a reflector that reflects radio waves transmitted from either a base station apparatus or a terminal apparatus, the control apparatus comprising:
a notification unit configured to provide the base station apparatus with information indicating a time duration from when setting of a reflection pattern of the reflector is started to when the setting is complete;
a reception unit configured to receive, from the base station apparatus, an instruction signal instructing to set a specific reflection pattern; and
a setting unit configured to set the specific reflection pattern to the reflector.

7. The control apparatus according to claim 6,
wherein the reception unit receives the instruction signal that includes information indicating a first timing at which the setting of the specific reflection pattern is to be complete, and
the setting unit performs setting of the specific reflection pattern of the reflector so as to complete the setting at the first timing.

8. The control apparatus according to claim 6,
wherein the notification unit provides the base station apparatus with UE Capability of the control apparatus, including information indicating the time duration.

9. The control apparatus according to claim 6,
wherein the notification unit transmits, to the base station apparatus, Message 1 or Message 3 of a random access procedure, uplink control information (UCI), or a message in a protocol layer for controlling the reflector, each of which includes information indicating the time duration.

10. The control apparatus according to claim 6,
wherein the notification unit provides information regarding the number of time slots corresponding to the time duration as information indicating the time duration.

11. A control method carried out by a base station apparatus, comprising:
receiving, from a control apparatus that controls a reflector that reflects radio waves transmitted from either the base station apparatus or a terminal apparatus, information indicating a time duration from when setting of a reflection pattern of the reflector is started to when the setting is complete;
determining a specific reflection pattern to be set for the reflector and a first timing at which setting of the specific reflection pattern is to be complete;
specifying a second timing that is either a certain timing earlier than the first timing by the time duration or a timing earlier than the certain timing; and
transmitting, to the control apparatus, an instruction signal instructing the control apparatus to set the specific reflection pattern, at the second timing.

12. A control method carried out by a control apparatus for controlling a reflector that reflects radio waves transmitted from either a base station apparatus or a terminal apparatus, the control method comprising:
providing the base station apparatus with information indicating a time duration from when setting of a reflection pattern of the reflector is started to when the setting is complete;
receiving, from the base station apparatus, an instruction signal instructing to set a specific reflection pattern; and
setting the specific reflection pattern to the reflector.

13. A non-transitory computer-readable storage medium that stores therein a program for enabling a computer provided in a base station apparatus to
receive, from a control apparatus that controls a reflector that reflects radio waves transmitted from either the base station apparatus or a terminal apparatus, information indicating a time duration from when setting of a reflection pattern of the reflector is started to when the setting is complete;
determine a specific reflection pattern to be set for the reflector and a first timing at which setting of the specific reflection pattern is to be complete;
specify a second timing that is either a certain timing earlier than the first timing by the time duration or a timing earlier than the certain timing; and
transmit, to the control apparatus, an instruction signal instructing the control apparatus to set the specific reflection pattern, at the second timing.

14. A non-transitory computer-readable storage medium that stores therein a program for enabling a computer provided in a control apparatus for controlling a reflector that reflects radio waves transmitted from either a base station apparatus or a terminal apparatus to
provide the base station apparatus with information indicating a time duration from when setting of a reflection pattern of the reflector is started to when the setting is complete;
receive, from the base station apparatus, an instruction signal instructing to set a specific reflection pattern; and
set the specific reflection pattern to the reflector.
